(19) United States
(12) Patent Application Publication
(10) Pub. No.: US 2025/0393044 A1
(43) Pub. Date: Dec. 25, 2025

(54) Enhancement for Power Saving in Hybrid Automatic Repeat Request (HARQ) Process for Long Term Evolution (LTE) and New Radio (NR) Wireless Networks

(71) Applicant: Apple Inc., Cupertino, CA (US)

(72) Inventors: Kanghao Jia, Hong Kong (HK); ChunLei Lin, Hong Kong (HK); Kok Yin Chan, Sydney (AU); Yike Liu, Hong Kong (HK); Pranav Tripathi, Cupertino, CA (US)

(21) Appl. No.: 18/749,285

(22) Filed: Jun. 20, 2024

(51) Int. Cl. H04W 72/1273; H04L 1/00; H04L 5/00; H04W 76/28

(52) U.S. Cl. CPC H04W 72/1273; H04L 1/0003; H04L 5/0053; H04W 76/28

(57) ABSTRACT

Methods and devices for saving power in a HARQ process are disclosed. The method includes a UE receiving and failing to decode a second PDSCH transmission from the network, the second PDSCH transmission including a second DL grant, a second NDI value, and a second MCS value. The method further includes the UE receiving a first DL PDSCH retransmission that includes a third DL grant, the second NDI value, and a third MCS value. The UE determines that the first DL PDSCH retransmission is a retransmission based on the third MCS value, and the UE skips part of a decoding of the first PDSCH and responds to the first DL PDSCH retransmission with a do not transmit (DTX).

### FIELD

The present application relates to wireless devices and wireless networks including devices, computer-readable media, and methods for power saving in a Hybrid Automatic Repeat re Request (HARQ) process in Long Term Evolution (LTE) and New Radio (NR) wireless communication systems.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, 5G NR, etc.

The ever-increasing number of features and functionality introduced in wireless communication devices also creates a continuous need for improvement in both the wireless communications and the wireless communication devices.

### SUMMARY

In general, embodiments disclosed herein are directed to methods and devices to facilitate power savings after a User Equipment (UE) has transmitted an Acknowledgement (ACK) for a Physical Downlink Shared Channel (PDSCH), and the UE misses or fails to decode a following new PDSCH with a downlink (DL) grant.

In one aspect, embodiments are directed to a method performed by a UE that includes transmitting an ACK to a network in response to an initial PDSCH transmission that includes a first DL grant, a first new data indicator (NDI) value, and a first Modulating Coding Scheme (MCS) value indicating a MCS. The method includes the UE failing to decode a second PDSCH transmission from the network, the second PDSCH transmission including a second DL grant, a second NDI value, and a second MCS value. The method further includes the UE receiving a first DL PDSCH retransmission that includes a third DL grant, the second NDI value, and a third MCS value. The method includes the UE determining that the first DL PDSCH retransmission is a retransmission based on the third MCS value, skipping part of a decoding of the first PDSCH based on the determination, and responding to the first DL PDSCH retransmission with a do not transmit (DTX).

The method may further include the UE receiving a second DL PDSCH retransmission that includes a fourth DL grant, the second NDI value, and a fourth MCS value. Such methods include the UE determining that the second DL PDSCH retransmission is a retransmission, skipping part of a decoding of the second PDSCH based on the determination, and responding to the second DL PDSCH retransmission with a DTX.

In another aspect, embodiments are directed to a method performed by a UE that includes the UE receiving a PDSCH transmission comprising: a first DL grant, a first NDI value, and a first MCS value indicating a MCS. The method includes the UE comparing the first NDI value to a previous NDI value, setting a DL UE state to indicate a dropped retransmission, and skipping part of a decoding of the PDSCH transmission based on the DL UE state. The method includes the UE transmitting a DTX in response to the first PDSCH transmission.

In another aspect, embodiments are directed to a wireless device that includes a processor and a transceiver configured to transmit an ACK to a network in response to an initial PDSCH transmission that includes a first DL grant, a first NDI value, and a first MCS value indicating a MCS. The UE fails to decode a second PDSCH transmission from the network, the second PDSCH transmission including a second DL grant, a second NDI value, and a second MCS value. The UE receives a first DL PDSCH retransmission that includes a third DL grant, the second NDI value, and a third MCS value. The UE determines that the first DL PDSCH retransmission is a retransmission based on the third MCS value, skips part of a decoding of the first PDSCH based on the determination, and responds to the first DL PDSCH retransmission with a do not transmit (DTX).

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter can be obtained when the following detailed description of various aspects is considered in conjunction with the following drawings.

FIG. 1 illustrates an example wireless communication system, according to some aspects.

FIG. 2 illustrates an example block diagram of a UE, according to some aspects.

FIG. 3 illustrates a base station (BS) in communication with a UE device, according to some aspects.

FIG. 4 illustrates a HARQ process in accordance with aspects of embodiments herein.

FIG. 5 illustrates a power saving HARQ procedure in accordance with embodiments herein.

FIG. 6 shows a flow diagram that illustrates one or more methods according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

After a UE has sent an ACK for a current PDSCH transmission, the network may send a new PDSCH along with a DL grant, or Physical Downlink Control Channel (PDCCH). The DL grant includes a New Data Indicator (NDI) and the Modulated Coding Scheme (MCS). The NDI is a known variable that is toggled, typically between 0 and 1, to distinguish different DL transmissions. That is, if the NDI different from the previous transmission, a new transmission is indicated. The MSC is also a known variable that includes a coding rate. Special values of MSC may be used for retransmissions. For example, a higher MSC value may be associated with a modulation order and transport block size that increases the chance of successfully decoding a transmission.

However, if the UE has missed or failed to decode the DL grant, then the UE will not decode PDSCH accordingly. In this case, the network will retransmit data with an updated MCS using the same NDI. The UE will receive the retransmission, but the UE will wrongly treat the retransmission as a new transmission in view of the NDI. The NDI mismatch will cause the layer 1 (L1) PDSCH Cyclic Redundancy Check (CRC) to fail. As a result, the UE will transmit a negative acknowledgement (NACK) to the network in response to the retransmission.

The network will continue attempting retransmission multiple times, and the UE will continue to transmit a NACK in response. Because the UE missed the initial DL transmission, the UE will not be able to decode the following retransmissions. Regardless, the UE will continue to as much as possible of the DL retransmissions, which is waste of computation power in the physical layer.

Techniques, such as HARQ soft combining, have been developed to help reconstruct data in the event of multiple retransmissions. However, when the UE misses the initial DL transmission, there is little chance that HARQ soft combining can be used to decode the DL retransmission data. Accordingly, embodiments may further provide power savings by avoiding attempts at unsuccessful HARQ soft combining.

Embodiments include methods and devices to facilitate the power savings when the UE misses or fails to decode a new PDSCH with a DL grant. Because the UE missed the initial DL transmission grant, in embodiments, the UE recognizes that the NDI toggled, but the MSC was updated in view of the need for a retransmission. The UE may then discard all of the DL retransmissions and skip the associated PDSCH decoding to save power. Further, the UE does not send an ACK/NACK to the network in response to the new PDSCH, but rather responds with a does not transmit (DTX). In this context, DTX refers to not transmitting an value. In embodiments, the UE may “transmit” a DTX, that is, purposely not including either an ACK or a NACK.

The following is a glossary of terms that may be used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (also “User Device” or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, etc. In general, the term “UE” or “UE device” can be broadly defined to encompass any electronic, computing, and/or telecommunications device (or combination of devices) which is transportable by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “base station” or “wireless station” has the full breadth of its ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB.’ If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” etc., may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” etc., are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually,” where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some aspects, “approximately” may mean within 0.1% of some specified or desired value, while in various other aspects, the threshold may be, for example, 2%, 3%, 5%, and so forth, as desired, or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism,” where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

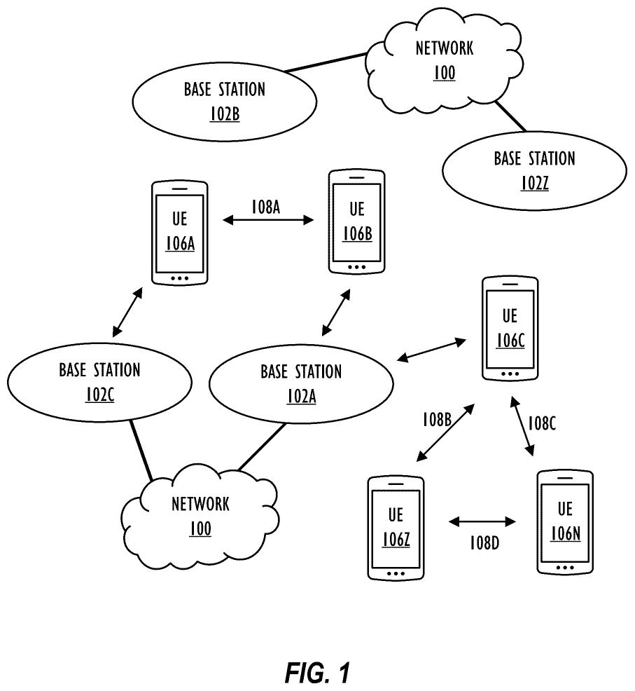

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, and the like) to facilitate the connections of the IoT network.

As shown in FIG. 1, the UEs 106, such as UE 106A and UE 106B, may directly exchange communication data via a PC5 interface 108A. Also, the UEs 106C, 106N, and 106Z, may collectively exchange communication data via a PC5 interfaces 108B, 108C, and 108D. In general, such PC5 interfaces are referred to as SL connections.

The PC5 interface 108 may comprise one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH). The PC5 interface 108 may be responsible for direct communication between devices (unicast), group messaging among select devices (groupcast), and broadcast messaging in accordance with embodiments disclosed herein.

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE, eNB, or by a gNB. For example, an RSU is a computing device coupled with radio frequency circuitry located on a roadside that provides connectivity support to passing vehicle UEs.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G NR base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to some of the cellular communication protocols discussed herein. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a set of resource elements. There are several different physical downlink channels that are conveyed using such resource blocks.

One such channel is the PDSCH that may carry user data and higher layer signaling to the UEs 106. The Physical Downlink Control Channel (PDCCH) may carry information about the transport format and resource allocations related to the PDSCH channel, among other things, in accordance with embodiments described herein. It may also inform the UEs 106 about the transport format, resource allocation, and the HARQ information related to the uplink shared channel, in accordance with embodiments described herein. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

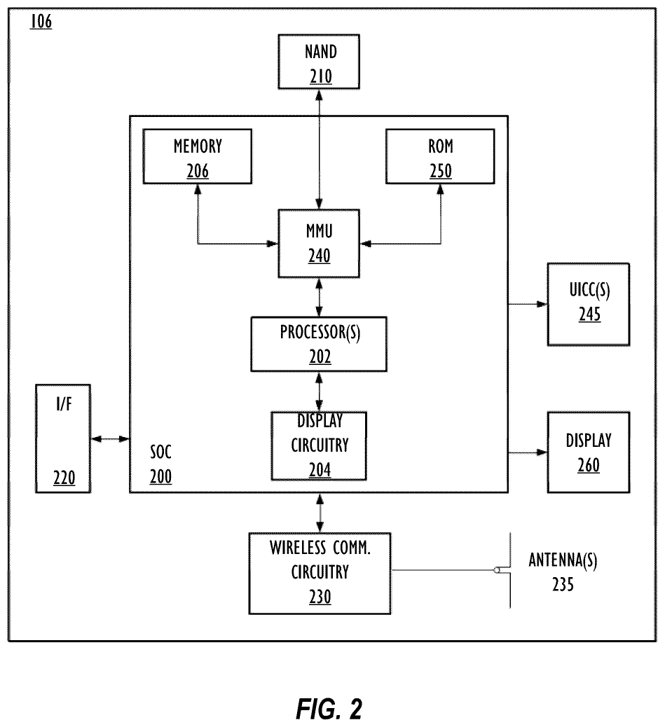

FIG. 2 illustrates user equipment 106 (e.g., one of the devices 106A through 106N) in communication with a base station 102 or other user equipment 106, according to some aspects. The UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid can be used for downlink transmissions from any of the base stations 102 to the UEs 106, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

As noted, the PDSCH may carry user data and higher layer signaling to the UEs 106. The PDCCH may carry information about the transport format and resource allocations related to the PDSCH channel, among other things, in accordance with embodiments described herein. It may also inform the UEs 106 about the transport format, resource allocation, and HARQ information related to the uplink shared channel, in accordance with embodiments described herein. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

FIG. 2 illustrates an example simplified block diagram of a communication device 106, according to some aspects. It is noted that the block diagram of the communication device of FIG. 2 is only one example of a possible communication device. According to aspects, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; etc.), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, etc.). In some aspects, communication device 106 may include wired communication circuitry (not shown), such as a network interface card, e.g., for Ethernet.

The wireless communication circuitry 230 may couple (e.g., communicatively; directly or indirectly) to one or more antennas, such as antenna(s) 335 as shown. The wireless communication circuitry 230 may include cellular communication circuitry and/or short to medium range wireless communication circuitry and may include multiple receive chains and/or multiple transmit chains for receiving and/or transmitting multiple spatial streams, such as in a multiple-input multiple output (MIMO) configuration.

In some aspects, as further described below, cellular communication circuitry 230 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The user interface elements may include any of various elements, such as display 260 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 245 that include SIM (Subscriber Identity Module) functionality, such as one or more UICC(s) (Universal Integrated Circuit Card(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein, e.g., by executing program instructions stored on a memory medium (e.g., a non-transitory computer-readable memory medium). Alternatively (or in addition), processor 202 may be configured as a programmable hardware element, such as an FPGA (Field Programmable Gate Array), or as an ASIC (Application Specific Integrated Circuit). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, etc.) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, etc.) configured to perform the functions of wireless communication circuitry 230.

### Example Base Station

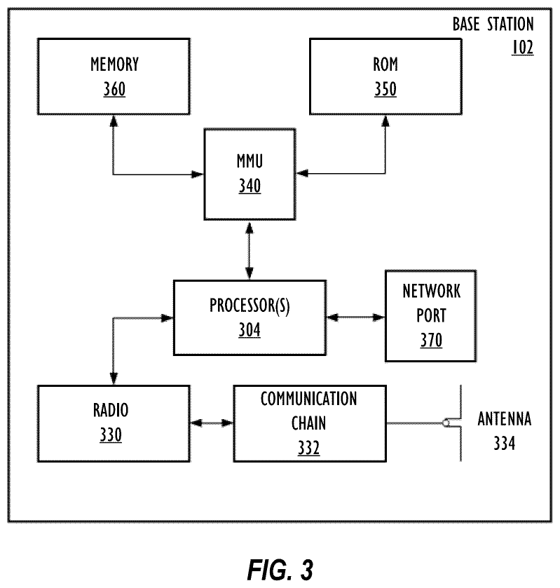

FIG. 3 illustrates an example block diagram of a base station 102, according to some aspects. It is noted that the base station of FIG. 3 is merely one example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIGS. 1 and 2.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, e.g., a 5G NR base station, or “gNB.” In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 304 of the base station 102 may be configured to implement or support implementation of part or all of the methods described herein, e.g., by executing program instructions stored on a memory medium (e.g., a non-transitory computer readable memory medium). Alternatively, the processor 304 may be configured as a programmable hardware element, such as an FPGA (Field Programmable Gate Array), or as an ASIC (Application Specific Integrated Circuit), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, etc.) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, etc.) configured to perform the functions of radio 330.

### Power Saving HARQ Procedures

As noted above, the PDSCH carries user data and higher layer signaling to the UEs. The PDCCH carries information about the transport format and resource allocations related to the PDSCH channel, among other things. Typically, the network transmits an initial PDSCH that includes a DL grant, the UE successfully receives and decodes the PDSCH transmission, and transmits an ACK in response to the PDSCH. However, if a UE misses or fails to decode a DL grant in a following PDSCH, UE and network resources are wasted in the subsequent retransmissions.

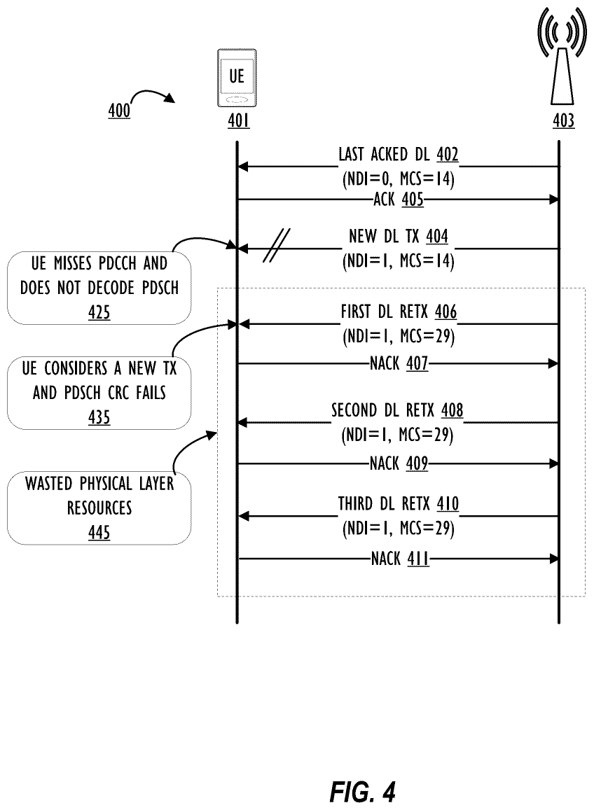

FIG. 4 illustrates a HARQ process 400, in accordance with aspects of embodiments herein. In FIG. 4, the network 403 has transmitted a last acknowledged (ACKed) DL transmission 402 with a DL grant, and the UE 401 has transmitted an ACK 405. In the last ACKed DL transmission 402, the NDI is 0, and the MCS is 14.

In the embodiments illustrated, a DL MCS 64 QAM table is configured for the MCS. The DL MCS 64 QAM table defines a relationship between an MCS index, modulation order (QM), and transport block size (TBS). In current LTE/NR procedures, the DL MCS 64 QAM table includes reserved indexes (28-31) that may be employed in embodiments herein, as illustrated below. The DL MCS 64 QAM table is known in LTE and NR; however, embodiments are not limited to such. The DL MCS 64 QAM table is for illustration purposes, and embodiments may employ other techniques of analyzing an MCS to determine to determine if a transmission is a re-transmission.

Returning to FIG. 4, after the UE 401 has sent the ACK 405 for the last ACKed DL transmission 402, the network 403 sends a new PDSCH transmission 404 that includes a DL grant (i.e., a PDCCH). The new PDSCH transmission 404 has an NDI=1 because the NDI will toggle between 0 and 1 in these examples. The new PDSCH transmission 404 also has an MCS=14. However, as shown at 425, the UE 401 either fails to receive the new PDSCH transmission 404 or the UE 401 fails to decode the DL grant in the new PDSCH transmission 404, which causes the new PDSCH transmission 404 to fail to decode.

In this case, the network 403 will retransmit data in a first DL retransmission (ReTx) transmission 406. The first DL ReTx 406 will have the same NDI=1, but the MCS will be changed. In this example, the first DL ReTx 406 uses a reserved MCS=29. The UE 401 successfully receives the first DL ReTx 406, but erroneously treats the DL grant in the first DL ReTx 406 as a new transmission based on the toggled NDI as shown at 435. This NDI mismatch will cause the L1 PDSCH CRC to fail.

Because the UE 401 has missed the new DL TX 404 at 425, the UE 401 will not be able to decode the data in the first DL ReTx 406 at 435. As a consequence, the UE 401 will transmit a NACK 407 to the network 403 as part of the HARQ procedure 400.

In response to the NACK 407, the network 403 will transmit a second DL ReTx 408. The second DL ReTx 408 will have the same NDI value of 1 and, in this example, the same reserved value MCS of 29. The UE 401 will receive the second DL ReTx 408, and again failing to decode, will transmit the NACK 408. This process is repeated again when the network 403 sends a third DL ReTx 410 (with NDI=1 and MCS=29) that the UE 401 fails to decode. In response to receiving the third DL ReTx 410, the UE 401 transmits the NACK 411.

In FIG. 4, the first DL ReTx 406 and the resulting NACK 407; the second DL ReTx 408 and the resulting NACK 409; and the third DL ReTx 410 and the resulting NACK 411 may be considered wasted resources in the physical layer, as illustrated at 445.

In the examples herein, the NDI is shown to toggle with each new transmission. That is, when the NDI value flips, a new transmission is indicated. However, one of ordinary skill in the art, in view of this disclosure, will appreciate that the embodiments are not limited as such. For example, embodiments of the network could assign a value (e.g., NDI=1) to a new transmission, and a different value (e.g., NDI=0) for a retransmission. As another example, an NDI=1 could indicate that the transmission or retransmission is carrying new data and an NDI=0 could indicate a retransmission of previously transmitted data. As another example, embodiments of the network could toggle the value for every transmission. Embodiments are presented in terms of current standards, i.e., a toggled value (e.g., lastND1=0, assignedNDI=1) is used for a new transmission and a non-toggled value (e.g., lastND1=0, assignedNDI=0) is used for a retransmission.

In embodiments, when the UE misses the initial DL transmission grant, the UE may mark the next DL grant as a retransmission. Then, the UE can discard all the retransmissions and skip the corresponding PDSCH decoding for the retransmissions.

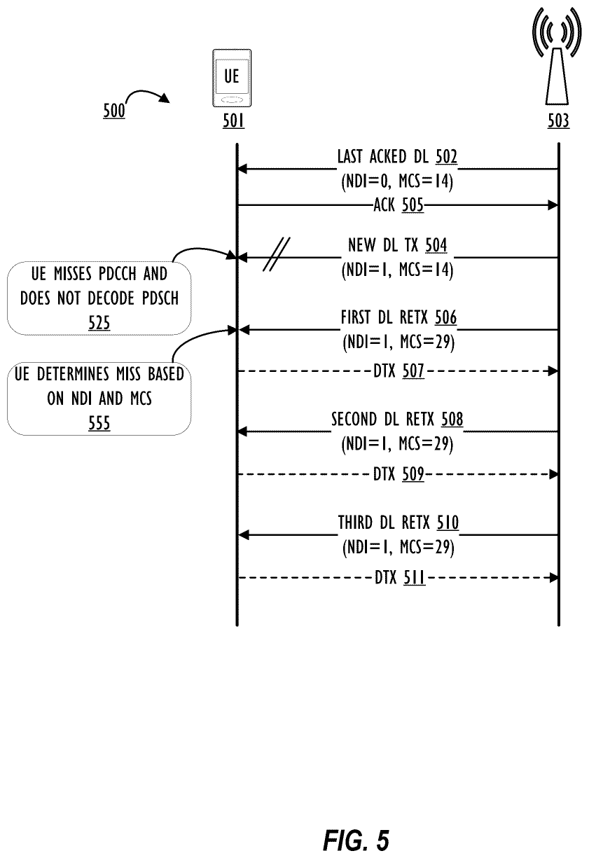

FIG. 5 illustrates a power saving HARQ procedure 500 in accordance with embodiments herein. In FIG. 5, the UE 501 has received a last ACKed DL 502 (e.g., an initial PDSCH) from the network 503, and the UE 501 has responded by transmitting the ACK 505. In this example, similar to FIG. 4, the last ACKed DL 502 includes an NDI=0 and an MCS=14.

The network 503 transmits a new DL transmission 506 that includes a toggled NDI (i.e., NDI=1) and an MSC=14. However as shown at 525, the UE 501 fails to decode the new DL transmission 506 from the network 503. The UE 501 may fail to decode the new DL transmission 506 for a number of reasons, such as an error in decoding the message or failing to receive the message entirely.

The network 503 will then send a first DL ReTx 506. The first DL ReTx 506 includes the same NDI (NDI=1) as the missed transmission. The first DL ReTx 506 also includes an updated MCS=29. As in the previous examples, the DL MCS 64 QAM table is configured. The UE 501 receives the first DL ReTx 506 and determines that the NDI has changed. The UE 501 further determines that that the MCS in the first DL ReTx 506 is an MCS reserved for retransmissions. Based on these determinations as shown at 555, the UE 501 recognizes that the first DL ReTx 506 is a retransmission, and the UE 501 marks the transmission as a retransmission.

After determining that the first DL ReTx 506 is a retransmission, the UE 501 can discard following retransmissions and skip the corresponding PDSCH decoding in such retransmissions. Further, the UE 501 does not send an ACK or a NACK, but rather indicates a DTX. That is, the UE 501 transmits a DTX 507 by not including an ACK or the NACK in the UCI of the uplink response.

The UE 501 may then receive a second DL ReTx 508. In response, the UE 501 will know the second DL ReTx 508 is a retransmission, e.g., based on the NDI, and the UE 501 will save power by skipping the PDSCH decoding and transmitting the DTX 509. The UE 501 may then receive a third DL ReTx 510 and save power by skipping decoding and transmitting the DTX 511. Accordingly, the UE 501 avoids wasting computing resources trying to fully decode the retransmissions, as well saving transceiver resources by transmitting multiple NACKs.

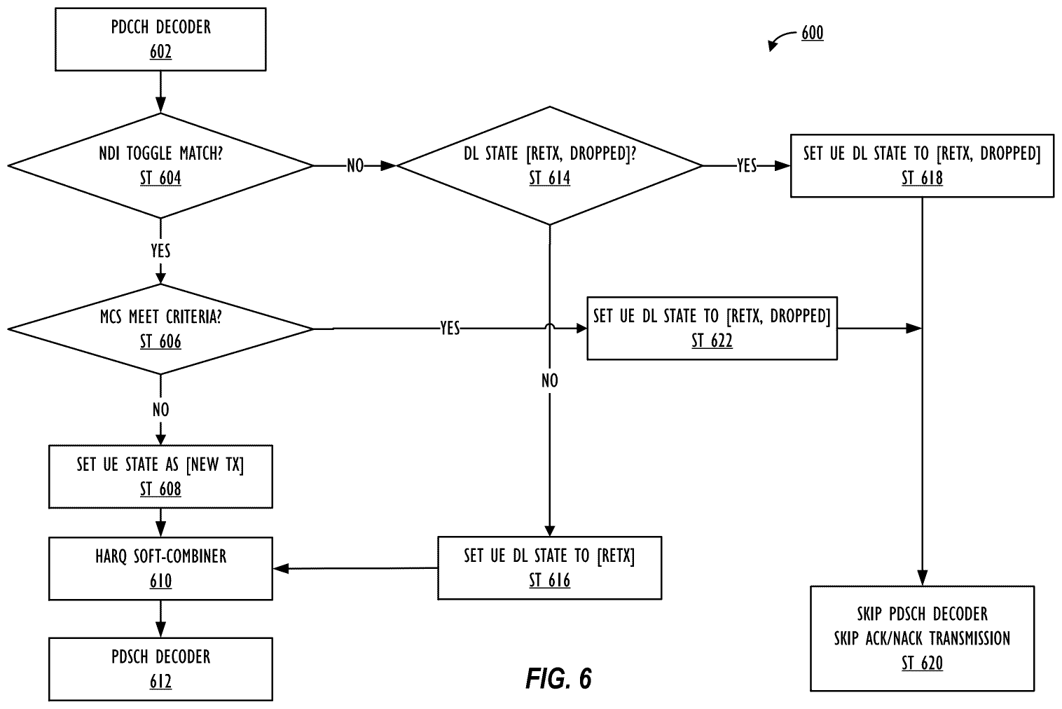

FIG. 6 shows an flow diagram 600 that illustrates one or more methods according to some aspects. FIG. 6 describes the various UE determinations and components used when a PDSCH with a DL grant is received. The PDCCH decoder 602 decodes the DL grant. The UE then compares the NDI received to the NDI of the previous DL grant to determine if the NDI has been toggled in step (ST) 604. If the NDI matches (Yes in ST 604), the UE determines if the MCS meets the criteria for a retransmission in ST 606. For example, the UE determines that the MCS value is a reserved value, such as being greater than 28 when using the DL MCS 64 QAM configuration. If the MCS does not meet the criteria for a retransmission (NO in ST 606), the UE sets the UE state to be a new transmission, e.g., set to [New Tx]. That is, based on the NDI and the MCS, the UE determines that the transmission is not a retransmission. The UE may then employ the HARQ soft-combiner 610 according to known soft combining techniques. The UE may then use the PDSCH decoder 612 to decode the PDSCH transmission.

As previously noted, when the UE misses an initial DL transmission, there is little chance that HARQ soft combining will be successful to decode the subsequent retransmissions. However, as illustrated in FIG. 6, embodiments may still employ HARQ soft-combining techniques when the initial DL transmission is received.

If the UE determines that the NDI has changed (No in ST 604), the UE checks to see if the previous DL state is indicated as a retransmission and if the transmission should be dropped, e.g., [ReTx, dropped], in ST 614. If the previous DL state is not indicated to be a dropped retransmission (NO in ST 614), the UE sets the UE DL state to a retransmission, e.g., [ReTx] in ST 616. At ST 616, the UE may determine that the transmission is a retransmission that should not be dropped and the necessary information from the transmission is sent to the HARQ soft-combiner 610.

If the previous DL state is already indicated to be a dropped retransmission (YES in ST 614), the UE then sets (or resets) the DL state to be a dropped retransmission, e.g., [ReTx, Dropped] in ST 618. Then, in ST 620, the UE skips the PDSCH decoder/decoding and skips transmission of the ACK/NACK by transmitting a DTX.

After the UE has determined that the NDI has changed (YES in ST 604), the UE may determine that the MCS meets the criteria for a retransmission that should be dropped (Yes in ST 606). In that case, the UE sets the UE DL state to be a dropped retransmission, e.g., [ReTx, Dropped]. The UE then skips the PDSCH decoder/decoding and skips the transmission of the ACK/NACK by transmitting a DTX in ST 620.

In the examples above, the reserved MCS=29 is used for the retransmissions, which the UE can use to determine that the initial transmission was missed when a DL MCS 64 QAM table is configured. For example, the UE may determine that the received MCS is greater than 28, indicating a reserved value. However, as previously mentioned, embodiments are not limited to using a reserved MCS index. One of ordinary skill in the art, in view of this disclosure, will appreciate that the embodiments may employ different techniques using the MCS to determine if the transmission is a retransmission to be dropped. For example, a specified range of MCS indexes may be established for retransmissions; detecting specific changes in the MCS; comparing MCS values (e.g., a higher MCS value indicates a retransmission); and/or other techniques may be envisioned.

Embodiments disclosed herein advantageously save computation power in the physical layer. Specifically, the UE saves power by skipping the decoding of a PDSCH, as well as skipping the ACK/NACK in response to the PDSCH.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method, e.g., any of a method aspects described herein, or, any combination of the method aspects described herein, or, any subset of any of the method aspects described herein, or, any combination of such subsets.

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A baseband processor configured to cause a User Equipment (UE) to:
transmit an acknowledgement (ACK) to a network in response to an initial Physical Downlink Shared Channel (PDSCH) transmission comprising: a first downlink (DL) grant, a first new data indicator (NDI) value, and a first Modulating Coding Scheme (MCS) value indicating a MCS;
attempt to decode a second PDSCH transmission from the network, the second PDSCH transmission comprising: a second DL grant, a second NDI value, and a second MCS value, wherein the attempt at decoding is unsuccessful;
receive a first DL PDSCH retransmission comprising: a third DL grant, the second NDI value, and a third MCS value;
determine that the first DL PDSCH retransmission is a retransmission based on the third MCS value; and
skip part of a decoding of the first DL PDSCH retransmission based on the determination; and
respond to the first DL PDSCH retransmission with a do not transmit (DTX).

2. The baseband processor of claim 1, wherein the baseband processor further causes the UE to:
receive a second DL PDSCH retransmission comprising: a fourth DL grant, the second NDI value, and a fourth MCS value;
determine that the second DL PDSCH retransmission is a retransmission;
skip part of a decoding of the second PDSCH based on the determination; and
respond to the second DL PDSCH retransmission with a DTX.

3. The baseband processor of claim 2, wherein determining that the second DL PDSCH retransmission is a retransmission is based on the second NDI.

4. The baseband processor of claim 2, wherein the third MCS value is equal to the fourth MCS value.

5. The baseband processor of claim 2, wherein the baseband processor further causes the UE to:
receive a third DL PDSCH retransmission comprising: a fifth DL grant, the second NDI value, and a fifth MCS value;
determine that the third DL PDSCH retransmission is a retransmission;
skip part of a decoding of the third PDSCH retransmission based on the determination; and
respond to the third DL PDSCH retransmission with a DTX.

6. The baseband processor of claim 1, wherein failing to decode a second PDSCH transmission comprises the UE failing to receive the second PDSCH transmission.

7. The baseband processor of claim 1, wherein the third MCS value is a reserved value.

8. A method performed by a User Equipment (UE), the method comprising:
receiving a Physical Downlink Shared Channel (PDSCH) transmission comprising: a first downlink (DL) grant, a first new data indicator (NDI) value, and a first Modulating Coding Scheme (MCS) value indicating a MCS;
comparing the first NDI value to a previous NDI value;
setting a DL UE state to indicate a dropped retransmission;
skipping part of a decoding of the PDSCH transmission based on the DL UE state; and
transmitting a do not transmit (DTX) in response to the first PDSCH transmission.

9. The method of claim 8, further comprising analyzing the first MCS value based on selection criteria.

10. The method of claim 9, wherein analyzing the first MCS based on selection criteria comprises determining that the MCS value is a reserved MCS value.

11. A wireless device comprising a processor and transceiver configured to:
transmit an acknowledgement (ACK) to a network in response to an initial Physical Downlink Shared Channel (PDSCH) transmission comprising: a first downlink (DL) grant, a first new data indicator (NDI) value, and a first Modulating Coding Scheme (MCS) value indicating a MCS;
attempting to decode a second PDSCH transmission from the network, the second PDSCH transmission comprising: a second DL grant, a second NDI value, and a second MCS value, wherein the attempt at decoding is unsuccessful;
receive a first DL PDSCH retransmission comprising: a third DL grant, the second NDI value, and a third MCS value;
determine that the first DL PDSCH retransmission is a retransmission based on the third MCS value; and
skip part of a decoding of the first DL PDSCH retransmission based on the determination; and
respond to the first DL PDSCH retransmission with a do not transmit (DTX).

12. The wireless device of claim 11, wherein the processor and transceiver are further configured to:
receive a second DL PDSCH retransmission comprising: a fourth DL grant, the second NDI value, and a fourth MCS value;
determine that the second DL PDSCH retransmission is a retransmission; and
respond to the second DL PDSCH retransmission with a DTX.

13. The wireless device of claim 12, wherein determining that the second DL PDSCH retransmission is a retransmission is based on the second NDI.

14. The wireless device of claim 12, wherein the third MCS value is equal to the fourth MCS value.

15. The wireless device of claim 12, wherein the processor and transceiver are further configured to:
receive a third DL PDSCH retransmission comprising: a fifth DL grant, the second NDI value, and a fifth MCS value;
determine that the third DL PDSCH retransmission is a retransmission; and
respond to the third DL PDSCH retransmission with a DTX.

16. The wireless device of claim 11, wherein failing to decode a second PDSCH transmission comprises the UE failing to receive the second PDSCH transmission.

17. The wireless device of claim 11, wherein the third MCS value is a reserved value.

18. The method of claim 8, further comprising:
receiving a second DL PDSCH retransmission comprising: a second DL grant, a second NDI value, and a second MCS value;
determining that the second DL PDSCH retransmission is a retransmission;
skipping part of a decoding of the second PDSCH based on the determination; and
responding to the second DL PDSCH retransmission with a DTX.

19. The method of claim 18, wherein determining that the second DL PDSCH retransmission is a retransmission is based on the second NDI.

20. The method of claim 18, wherein the second MCS value is equal to the first MCS value.
